(19) United States
(12) Patent Application Publication
(10) Pub. No.: US 2010/0324875 A1
(43) Pub. Date: Dec. 23, 2010

(54) PROCESS FOR ORTHODONTIC, IMPLANT AND DENTAL PROSTHETIC FABRICATION USING 3D GEOMETRIC MESH TEETH MANIPULATION PROCESS

(76) Inventor: Thomas K. Kalili, Beverly Hills, CA (US)

Correspondence Address: BANNER & WITCOFF, LTD., TEN SOUTH WACKER DRIVE, SUITE 3000, CHICAGO, IL, 60606, US

(21) Appl. No.: 12/866,930

(22) PCT Filed: Feb. 12, 2009
(86) PCT No.: PCT/US09/33891

§ 371 Date: Aug. 10, 2010

Related U.S. Application Data
(60) Provisional application No. 61/027,985, filed on Feb. 12, 2008.

(51) Int. Cl. G06G 7/48

(52) U.S. Cl. 703/11

(57) ABSTRACT

The process for orthodontic, implant and dental prosthetic fabrication using 3D geometric mesh teeth manipulation process is a system for manipulating teeth as a 3D geometric mesh. The system is used to create an efficient and completely digital processing system on top of 3D mesh manipulation tools. Moreover, the process utilizes a monitored interventional technique to allow for teeth movement based on dentist evaluation at each phase and creates custom aligners for each and every visit based on the lab slip.

This application claims the benefit of U.S. Provisional Application No. 61/027,985 filed Feb. 12, 2008, which is incorporated herein by reference in its entirety.

### BACKGROUND

Currently, there are numerous techniques for orthodontic, implant and or dental prosthetic fabrication and treatments for repositioning misaligned teeth and improving bite configurations. Two-dimensional (2D) and three-dimensional (3D) digital imaging technology has been used to assist in dental and orthodontic treatments. Many treatment providers use some form of digital imaging technology to study the dentitions of patients. 2D and 3D imaging data is used in forming a digital model of a patient's dentition, including models of individual dentition components. Such models are useful, among other things, in developing an orthodontic treatment plan for the patient, as well as in creating one or more orthodontic appliances to implement the treatment plan. This type of 3D digital imaging technology uses algorithms to automatically find and segment teeth. More specifically, computer aided algorithms are used to automate teeth detection, separation and root pivot identification. Currently, there is a need in the art to create an efficient and completely digital processing system on top of 3D mesh manipulation tools.

### SUMMARY

The summary is provided to introduce a selection of concepts in a simplified form that are further described below in the detailed description. This summary is not intended to identify key features or essential features of the subject matter, nor is it intended to be used to limit the scope of the subject matter.

The 3D geometric teeth manipulation process is able to subdivide and segment a digital dentition model into models of individual dentition components by selecting desired boundaries of teeth which require orthodontic movement, implant and/or dental prosthetics using the natural triangulation within the digital model. These dentition components include, but are not limited to, tooth movement, removable prosthesis, temporization, tooth dental prosthetics models, implants and surgical corrections for orofacial abnormalities.

One aspect of the invention, focuses on user input to determine teeth detection, separation and root pivot identification. The invention takes advantage of CAD/CAM software with custom developed software add ins to allow post scan cleaning, aligning and customized tooth movement. The operations normally requiring in excess of 135 steps is reduced to 10 steps through the use of customized algorithms.

Another aspect of the invention, involves obtaining raw data from a three-dimensional (3D) scanner and transforming the 3D digital model into a water-tight geometric mesh. A series of 3D algorithms and geometric manipulation tools then allows for input to move and adjust each individual tooth.

In a further aspect of the invention, a computer subdivides the data elements in the dentition model by finding the closest matching polygonal boundary between the 3D cutting surfaces. Afterwards individual mesh data is merged into a single mesh and any outlying and duplicate polygons are removed. Specifically, the process does not physically segment the teeth to a new mesh rather it only selects the required polygons that need to be moved. Moreover, the polygonal faces in the merged mesh are removed, turning the mesh shell back into a point cloud.

In another aspect of the invention, a new 3D topology is created from the merged point cloud. The points are first filtered for even distribution, redundant points are removed, errors in the polygonal surface are fixed, and the geometric mesh is reduced in size to a manageable size.

In an additional aspect of the invention, a clean and water tight 3D geometric mesh is created. The points are filtered for even distribution, holes are filled, spikes are removed and noise is smoothed over.

In another aspect of the invention, each tooth is separated along existing 3D geometric boundaries using a pen tool that separates the mesh along the approximate closest polygon edges. After a closed loop has been selected, the enclosing faces are separated from the main polygonal shell.

In a further aspect of the invention, the separated tooth can then be rotated, translated, intruded, extruded, able to upright posterior teeth, trimmed at the interproximal sides to allow room for orthodontic movement in cases of crowding, referred to as interproximal reduction (IPR), and tilted along any geometric axis as determined by its bounding box. The tooth root or rotation center is determined using the bottom center of the tooth's bounding box, and then additional tools are presented to the user to allow them to move the rotation center if it needs to be adjusted. The center point of rotation is determined using the bottom center of the bounding box. The exact location can be adjusted using a number of controls. Custom algorithms are then used to choose the rotational center point. This is critical as each tooth within the same teeth set may have unique requirements. Each tooth's rotation center needs to be evaluated independently in order to provide the best final product.

In another aspect of the invention, each digital movement of the patient's arch or dentition at each phase of treatment, which is password driven, can be visualized in sequential photos and or video by the dentist, patient and manufacturing divisions.

In a further aspect of the invention, after each individual tooth has been selected and moved in their new position, the tooth shell is merged back into the master shell.

In another aspect of the invention, the 3D geometric mesh teeth manipulation process utilizes a “monitored interventional technique” to allow for teeth movement based on dentist evaluation at each phase and creates custom aligners in clear and various colors based on patient selection for each and every visit as per lab slip completed and or confirmed by the dentist.

In a further aspect of the invention, upon orthodontic, implant and/or prosthetic preparation on the digital model of the patient, the aligner and or dental prosthetics are fabricated using one of two processes. One option is to print the digital file and fabricate the orthodontic aligner, implant and/or dental prosthetics directly on the printed digital model. The second option is to have the orthodontic aligner, implant and/or dental prosthetics milled directly off of the digital file.

In another aspect of the invention, the orthodontic aligners are composed of a polymer material ranging in thickness between 0.02 to 0.05 inches bust most commonly 0.03 to 0.04 inches. The final stabilization stage aligner may consist of filler particles and be thicker for greater stability than the first series of aligners during orthodontic movement. The aligner consisting of a higher modulus (stiffer) outer layer and an internal lower modulus (softer) layer to allow for greater flexibility, more gradual and longer duration of tooth movement per aligner leading to less relative stress to teeth and associated bone.

### BRIEF DESCRIPTION OF THE DRAWINGS

FIG. 1 shows a flow chart for a technology cycle in accordance with an aspect of the invention.

FIG. 2 shows a flow chart illustrating the steps in taking raw 3D scan data, generating a usable 3D mesh, and ultimate mesh that represents the desired teeth movement in accordance with an aspect of the invention.

FIG. 3 shows a raw 3D cross section of a dentition model in accordance with an aspect of the invention.

FIG. 4 shows a 3D cross section of a dentition model illustrating an after scan preparation in accordance with an aspect of the invention.

FIG. 5 shows a 3D cross section of a dentition model illustrating an after re-building topology in accordance with an aspect of the invention.

FIG. 6 shows a 3D cross section of a dentition model illustrating after mesh cleanup in accordance with an aspect of the invention.

FIG. 7 shows a 3D cross section of a dentition model illustrating an after tooth selection in accordance with an aspect of the invention.

FIG. 8 shows a 3D cross section of a dentition model illustrating the selection polygon edges in accordance with an aspect of the invention.

FIG. 9 shows a 3D cross section of a dentition model illustrating after tooth editing in accordance with an aspect of the invention.

FIG. 10 shows a 3D cross section of a dentition model illustrating tooth shape manipulation in accordance with an aspect of the invention.

FIG. 11 shows an editing tool to select a tooth in accordance with an aspect of the invention.

FIG. 12 shows a 3D cross section of a dentition model illustrating isolation by triangulation in accordance with an aspect of the invention.

FIG. 13 shows the creation of an on-line lab slip in accordance with an aspect of the invention.

FIG. 14 shows the creation of a dental prosthetic and orthodontic aligner in accordance with an aspect of the invention.

FIG. 15 shows the final aligner in accordance with an aspect of the invention.

FIG. 16 shows the use of a Bracketless Anti Resorption technique in accordance with an aspect of the invention.

FIG. 17 shows a clean up scan using a Bracketless Anti Resorption technique in accordance with an aspect of the invention.

FIG. 18 shows the use of a preprosthetic orthodontics technique in accordance with an aspect of the invention.

FIG. 19 shows a 3D cross section of a dentition model illustrating a molar uprighting technique for a dental prosthetic in accordance with an aspect of the invention.

FIG. 20 shows a 3D cross section of a dentition model illustrating a molar uprighting technique for an implant in accordance with an aspect of the invention.

FIG. 21 shows a 3D cross section from a side view of a dentition model illustrating a molar uprighting technique for a dental prosthetic in accordance with an aspect of the invention.

### DETAILED DESCRIPTION

The 3D geometric teeth manipulation process is a powerful and unique system for manipulating teeth as a 3D geometric mesh. The system may create an efficient and digital processing system on top of 3D mesh manipulation tools. The result may be a toolbox of specialized 3D tooth processing algorithms that enable the user to process teeth in 3D space quickly and effectively. Moreover, the process may allow for teeth processing time to be nearly 10 times faster than using standard 3D or physical tools.

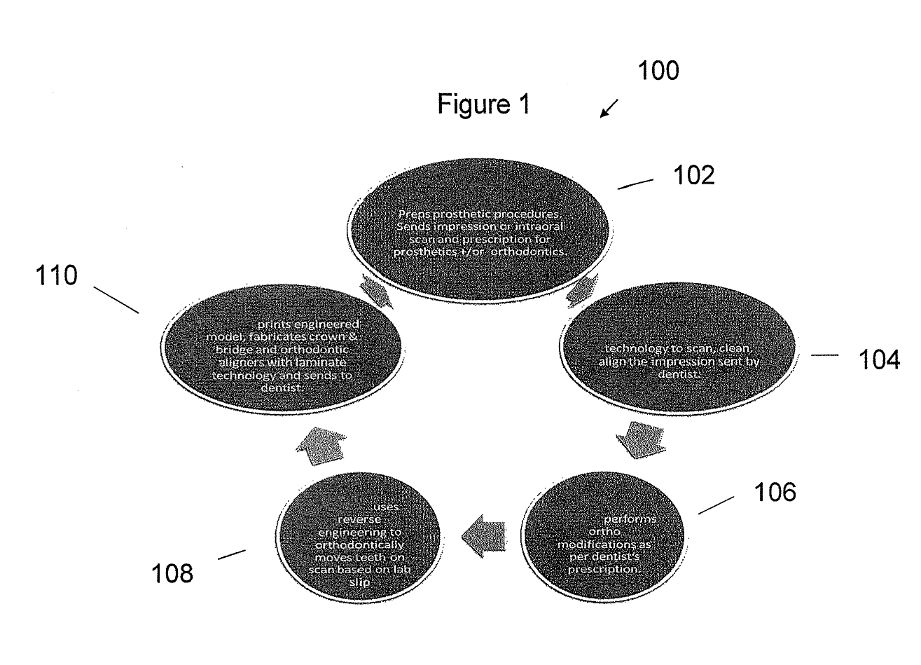

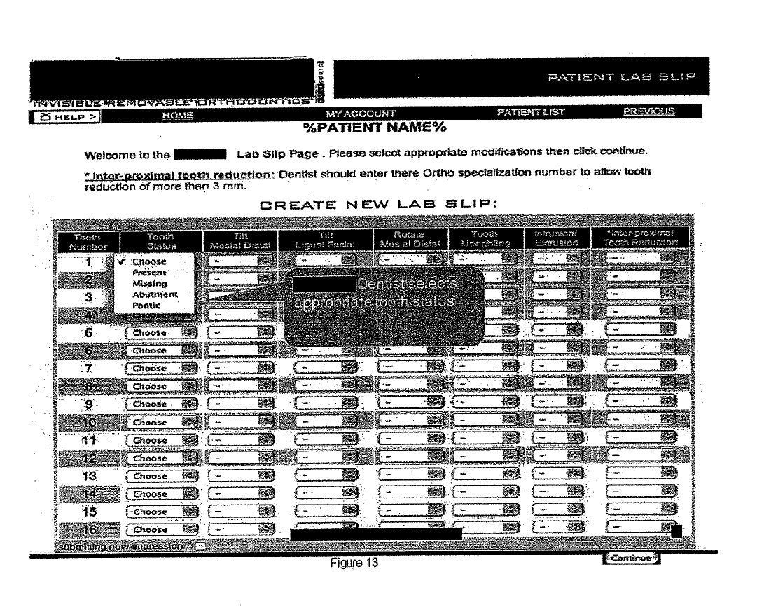

FIG. 1 illustrates a flow chart for a technology cycle 100. The first step 102 of the technology cycle prepares the prosthetic procedure and sends the impression or intraoral scan and prescription for prosthetics and/or orthodontics of the patient's dentition to the technology center. The second step 104 of the technology cycle may use 3D geometric mesh technology to scan, clean and align the impression sent by the dentist. The third step 106 of the technology cycle may create an online lab slip by performing ortho-modifications as per the dentist's request using 3D geometric mesh technology as further illustrated in FIG. 13. The fourth step 108 of the technology cycle may use CAD technology to align and orthodontically move teeth on the scan based on the online lab slip. The fifth and final step 110 of the technology cycle may use CAM technology to print the engineered model in order to fabricate dental prosthetics and orthodontic aligners with laminate technology and to send these newly fabricated aligners to the dentist. The fabricated aligners may be used to reposition misaligned teeth and improve bite configurations for improved cosmetic appearance and dental function.

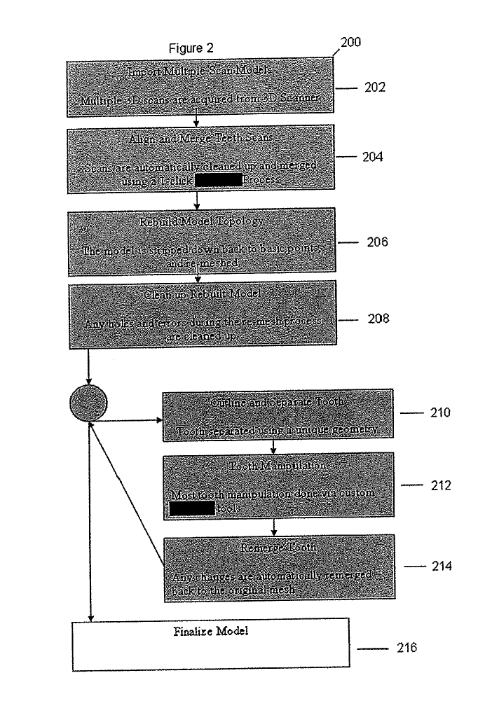

FIG. 2 shows a flow chart 200 illustrating the major steps in taking raw 3D scan data, generating a usable 3D mesh, and ultimate mesh that represents the desired teeth movement. The first step 202 of the flow chart may import multiple 3D scan models from multiple 3D scanners. The second step 204 of the flow chart may align and merge the 3D teeth scan models using the 3D geometric mesh and teeth manipulation process. The third step 206 of the flow chart may rebuild the 3D model topology by stripping down the 3D scan model to basic points and re-meshing the 3D scan model using the toolbox. The fourth step 208 of the flow chart may clean up and rebuild the 3D mesh model by cleaning up any holes and errors during the re-meshing process. The fifth step 210 of the flow chart may outline and separate each tooth in the 3D mesh model using unique geometry. The sixth step 212 of the flow chart may manipulate the teeth in the 3D mesh model by using custom algorithms. The seventh step 214 of the flow chart may remerge the teeth back to the original 3D mesh model. The eighth and final step 216 of the flow chart may finalize the 3D mesh model and print the model in order to fabricate dental prosthetics and orthodontic aligners with laminate technology.

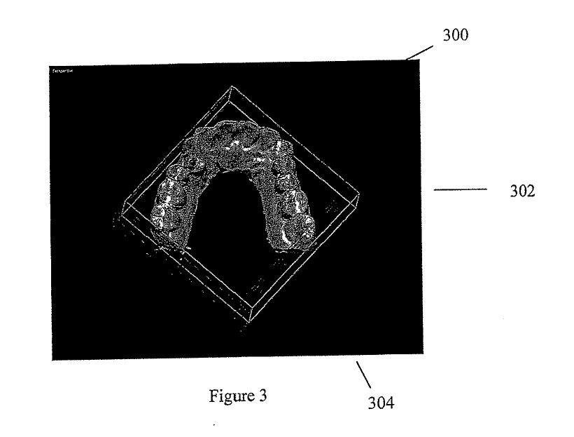

FIG. 3 illustrates a raw 3D cross section 300 of a dentition model. The 3D geometric mesh teeth manipulation process may begin by taking raw data 302 from 3D scanners and transforming it into a water-tight geometric mesh 304. A series of 3D algorithms and geometric manipulation tools then allows the user to move and adjust each individual tooth. Inputs may be 0-N sets of 3D geometric meshes from a 3D scanner.

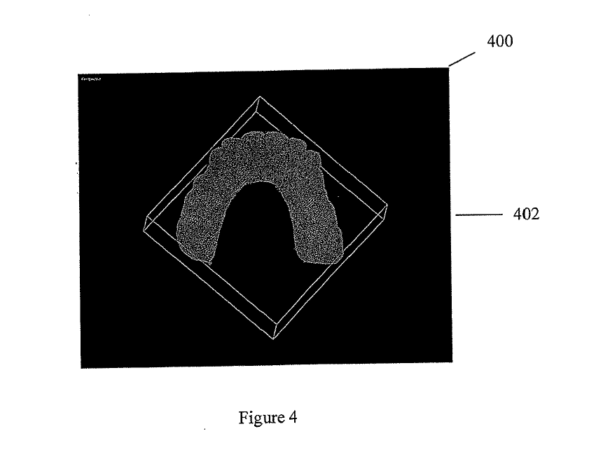

FIG. 4 illustrates a 3D cross section of a dentition model after scan preparation 400. The next step in the 3D geometric mesh teeth manipulation process may be aligning and merging the 3D data. Additionally, a digital cutting surface may be created by pulling back a curve, “removing” connections underneath, and effectively removing points from the model which creates a hole, or breaks individual triangles on the tooth. Afterwards, individual mesh data may be merged into a single mesh, and any outlying and duplicate polygons may be removed. Specifically, the process does not physically segment the teeth to a new mesh rather it only selects the required polygons that need to be moved. The polygonal faces in the merged mesh may be removed, turning the mesh shell back into a point cloud 402.

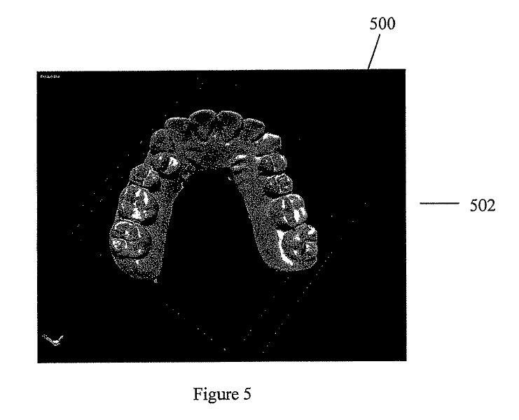

FIG. 5 illustrates a 3D cross section of a dentition model after re-building topology 500.

The next step in the 3D geometric mesh teeth manipulation process may be to create a new 3D topology 502 on top of the existing point cloud. The points may be first filtered for even distribution, redundant points may be removed, errors in the polygonal surface may be fixed, and the mesh may be reduced in size to manageable size.

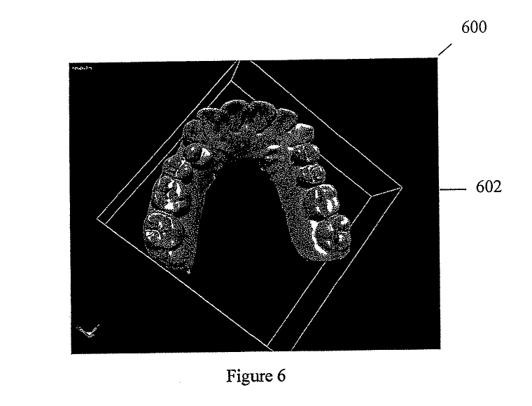

FIG. 6 illustrates a 3D cross section of a dentition model after mesh cleanup 600. The next step in the 3D geometric mesh teeth manipulation process may be mesh cleanup. The points may be filtered for even distribution, holes may be filled, spikes may be removed, and noise may be smoothed over. This may ensure a clean and water tight 3D mesh 602.

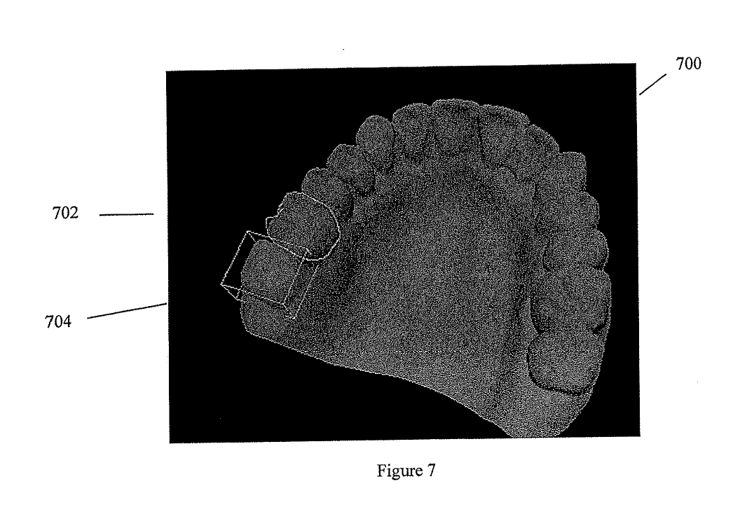

FIG. 7 illustrates a 3D cross section of a dentition model after tooth selection 700 and

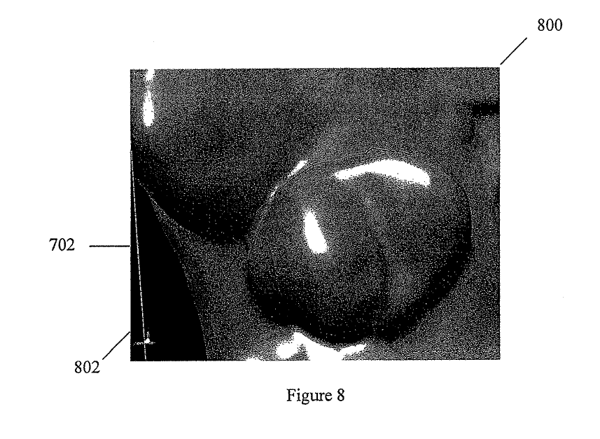

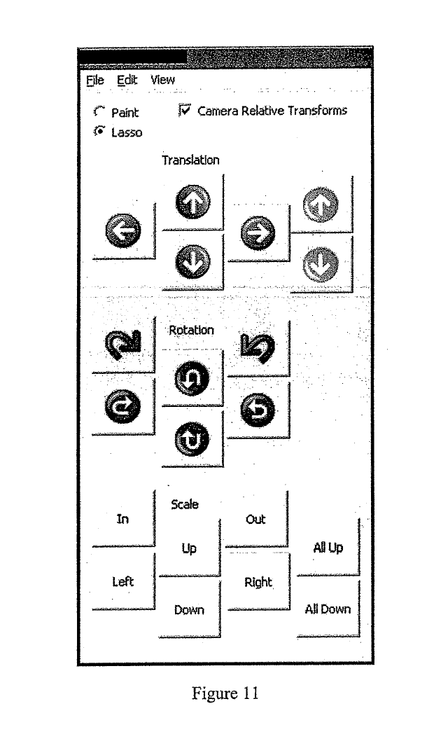

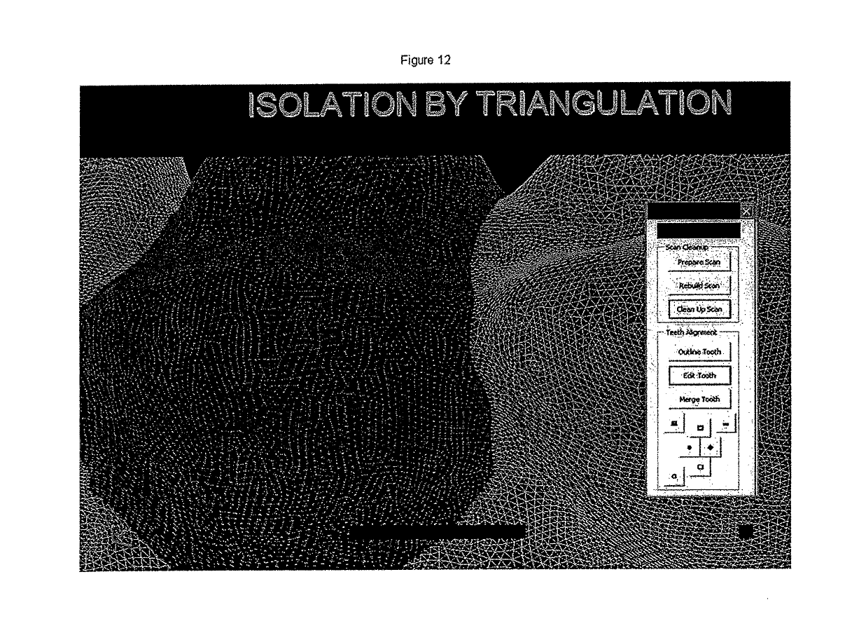

FIG. 8 illustrates a 3D cross section of a dentition model with selection polygon edges 800. Each tooth 702 may be selected along existing 3D geometric boundaries 704 using a lasso, paint or pen tool that selects polygons along the approximate closest polygon edges 802. The tooth selection editing tool is illustrated in FIG. 11. Each tooth 702 may also be isolated by triangulation as illustrated in FIG. 12. After a closed loop has been selected, the enclosing faces are highlighted and may be moved from the main polygonal shell.

The editing tool may support both intrusion and extrusion controls. The width and sides of the tooth selected may be adjusted by the editing tool as well. Multiple models may be loaded and the differences compared in a before and after case analysis. Additionally, the editing tool may allow the user to create in between movements from the starting and final positions. The desired ending position of the selected tooth may be determined and worked backwards to determine the necessary steps required to get there.

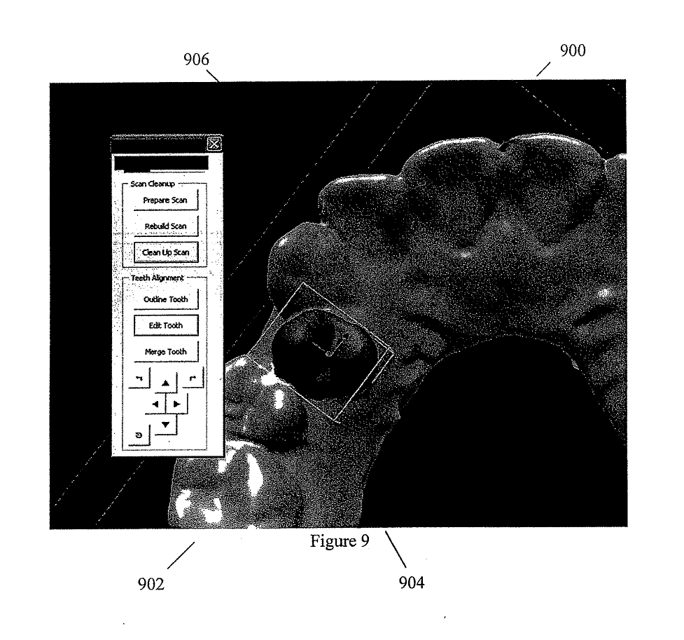

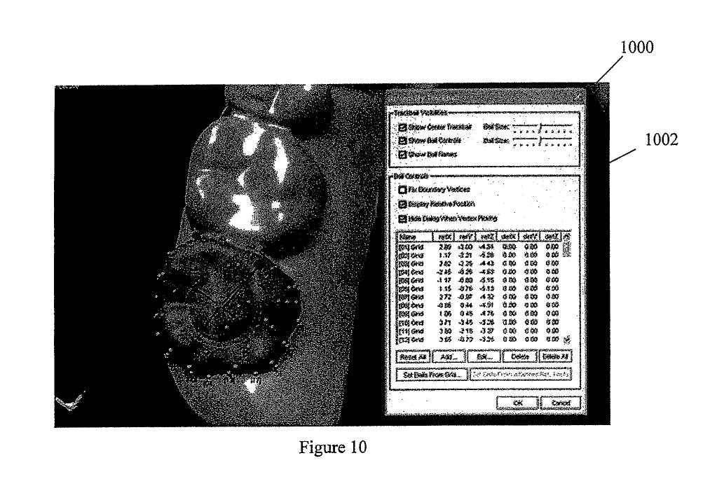

FIG. 9 illustrates a 3D cross section of a dentition model after tooth editing 900. Each selected tooth 902 may be rotated, translated, intruded, extruded, able to upright posterior teeth, trimmed at the interproximal sides to allow room for orthodontic movement in cases of crowding, referred to as interproximal reduction (IPR), and tilted along any geometric axis as determined by its bounding box 904. The center point of rotation 906 may be determined using the bottom center of the bounding box 904. The location may be adjusted using a number of controls. As the tooth is moved, the final mesh is updated. Custom algorithms may be used to choose the rotational center point. This is critical as each tooth within the same teeth set may have unique requirements. Each tooth's rotation center may need to be evaluated independently in order to provide the best final product. Each digital movement of the patient's arch or dentition at each phase of treatment, which is password driven, may be visualized in sequential photos and or video by the dentist, patient and manufacturing divisions. FIG. 10 illustrates a 3D cross section of a dentition model during tooth shape manipulation 1000. For more complex tooth shape changes select parts of the tooth may be moved and deformed using a trackball 1002 or FFD control.

After each tooth is adjusted using the 3D geometric mesh teeth manipulation process, based on examination of the patient, aligners with laminate technology may be fabricated. The aligners may be fabricated based on dentist evaluation at each phase and create custom aligners in clear and various colors based on patient selection for each and every visit as per lab slip completed and/or confirmed by the dentist. Upon orthodontic, implant and/or dental preparation on the digital model of the patient, the aligner and/or dental prosthetic may be fabricated using one of two processes. One option may be to print the digital file and fabricate the orthodontic aligner, implant and/or dental prosthetic directly on the printed digital model. The second option may be to have the orthodontic aligner, implant and/or dental prosthetic milled directly off of the digital file.

More specifically laser bed technology may be used to fabricate the aligner with the following steps: (a) scan the impression or integrate, (b) print the polycarbonate, (c) apply the inner material with polyurethane, (d) heat seal to get the bond, (e) then a hydroforming space bladder may be filled with water or compressed air, and (f) 3D audit accuracy using laser and photoelastic analysis may be performed to compare for accuracy between the aligner and the scanned model directly from the patient.

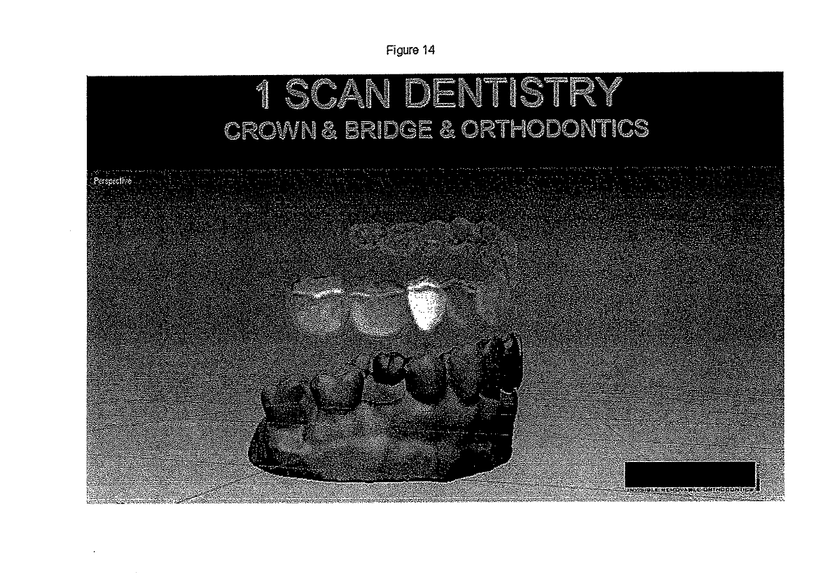

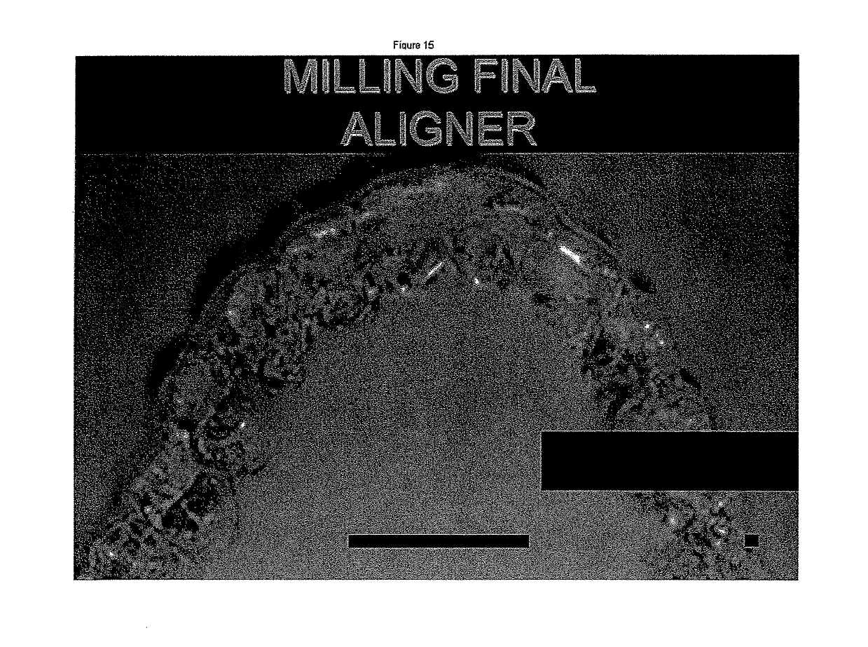

The aligners may be used not only for orthodontics but for removable prosthesis, temporization, dental prosthetics, implants and surgical corrections for orofacial abnormalities as illustrated in FIGS. 14 and 15. The orthodontic aligners may be composed of a polymer material ranging in thickness between 0.02 to 0.05 inches but most commonly 0.03 to 0.05 inches. The final stabilization stage aligner may consist of filler particles and be thicker for greater stability than the first series of aligners during orthodontic movement. The aligner consisting of a higher modulus (stiffer) outer layer and an internal lower modulus (softer) layer to allow for greater flexibility, more gradual and longer duration of tooth movement per aligner leading to less relative stress to teeth and associated bone. Additionally, the aligners may be used as bleaching trays.

Additionally, the 3D geometric mesh teeth manipulation process may have the ability to adhere orthodontic brackets to the internal aspect of the laminated aligners for conventional orthodontic treatment. This may be achieved by placing markings on the digital model for the location of the brackets to automate bracket placement on the internal aspect of the laminated aligners. The aligner may be then sent to the practitioner for insertion over the patient's mouth and via light cure or other means the brackets may be pre-positioned into proper location for activation by the practitioner.

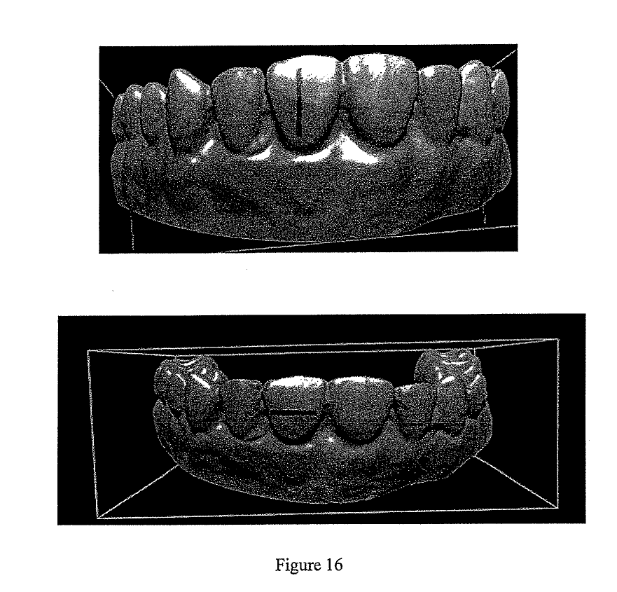

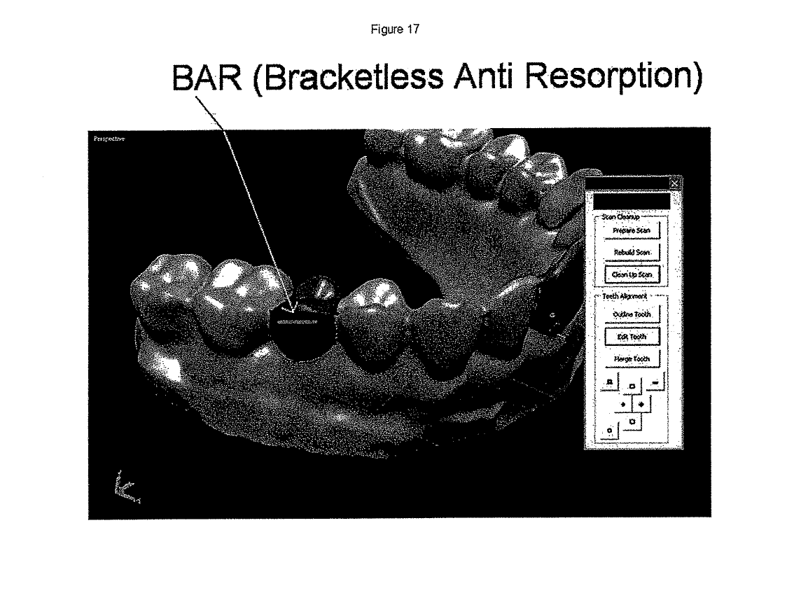

Moreover, as illustrated in FIGS. 16 and 17 an area may be marked on the digital model and the mesh may be deformed to include a groove. Upon fabrication of the orthodontic aligner, the groove may be translated into a Bracketless Anti Resorption. Upon insertion of the orthodontic appliance by the patient, the Bracketless Anti Resorption which may be composed of the lower modulus (softer) internal lining may compress and gradually may recover thereby allowing greater orthodontic movement.

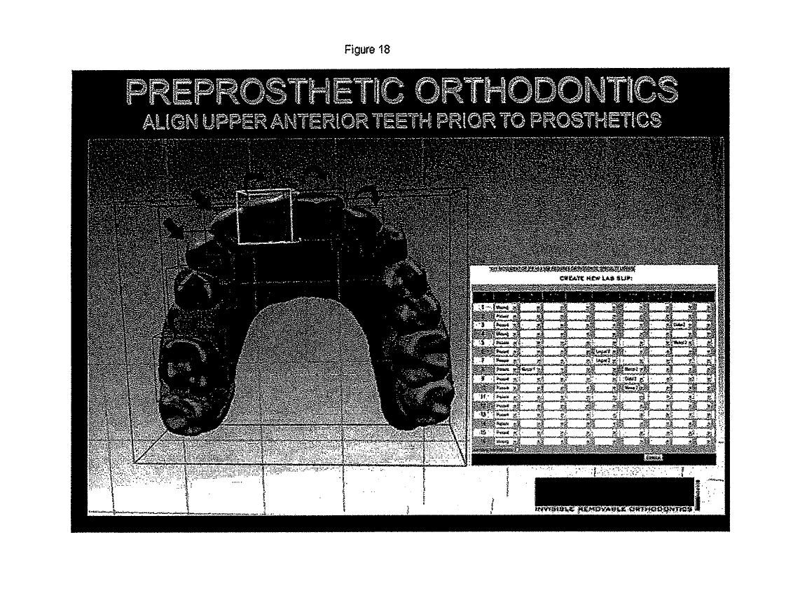

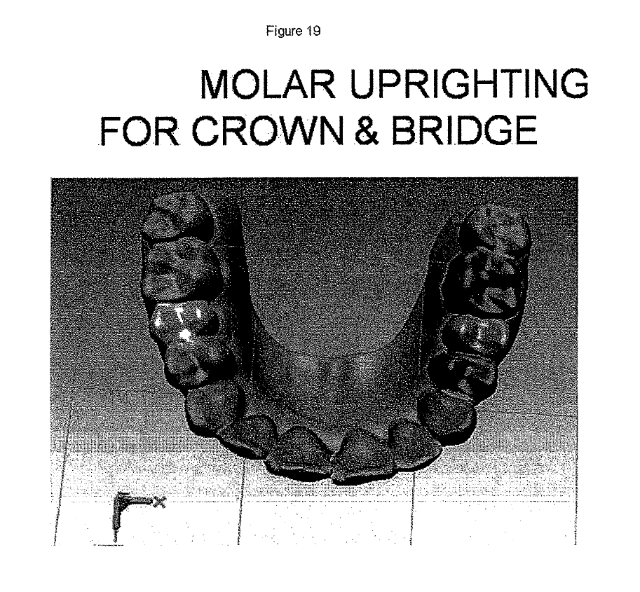

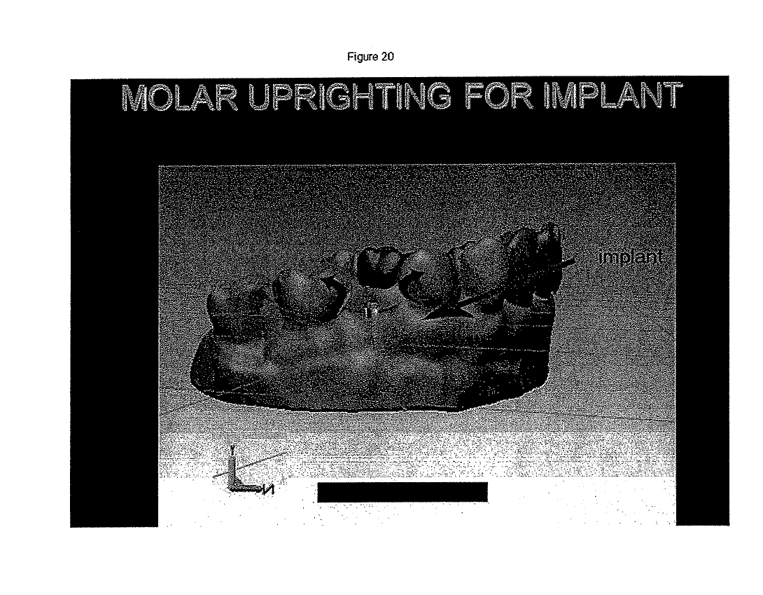

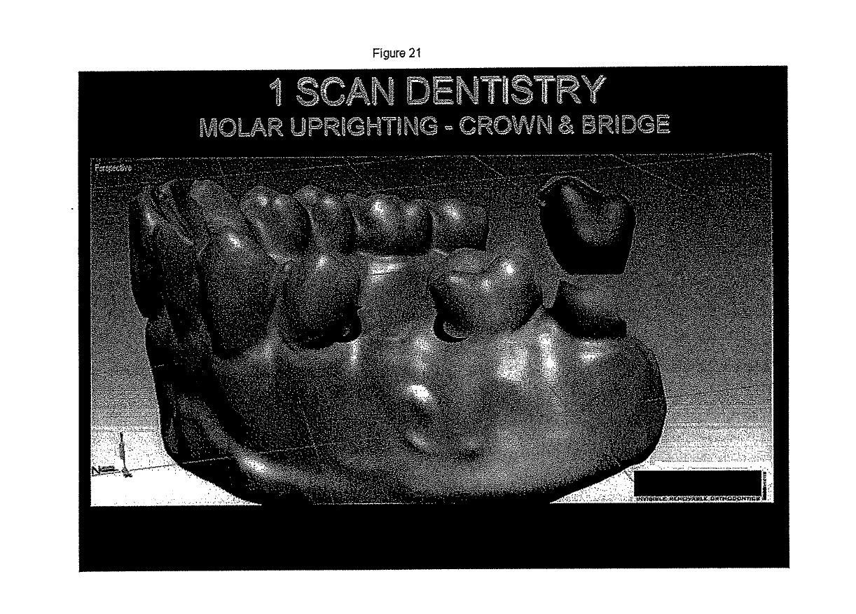

Additionally, as illustrated in FIG. 18, the 3D geometric mesh teeth manipulation process may not only perform orthodontic movement but in addition the process may set itself right into performing what is referred to as Pre-prosthetic orthodontics. This is whereby, for example, a tooth is missing or had to be pulled in which the adjacent teeth may drift into the empty space. Accordingly, there is insufficient room for a new tooth in the form of a bridge or implant to be placed in the place of the missing tooth. As illustrated in FIGS. 19, 20 and 21 the process may be able to both move teeth and perform molar uprighting to move the drifted teeth back into their original position to allow room for dental procedures such as bridge and or implants to be fabricated. Furthermore, as a result, the process may allow the preparation for the teeth for dental prosthetic work by taking an impression of the teeth and scanning into the system. One scan may allow not only fabrication of an aligner to straighten teeth but it may also perform molar uprighting for dental prosthetic work using CAD/CAM technology all from one scan or impression.

While particular embodiments of the present invention have been illustrated and described, it will be obvious to those skilled in the art that various changes and modifications may be made without departing from the spirit and scope of the invention.

1. A method of teeth manipulation for use in creating dental prosthetics, the method comprising:
a) receiving an intra oral scan;
b) receiving an on-line lab slip;
c) generating a model topology based on the received intra oral scan;
d) performing ortho-modifications using a three dimensional mesh incorporated on top of generated model topology, the ortho-modifications based on the received on-line lab slip;
e) manipulating teeth placement; and
f) creating a dental prosthetic based on the manipulated teeth placement.

2. The method of claim 1, wherein the received intra oral scan is created using a 3-D scanner and printer.

3. The method of claim 1, wherein step a) further includes receiving a dental impression.

4. The method of claim 1, wherein the three dimensional mesh comprises a water tight geometric mesh.

5. A computer implemented method for creating dental prosthetics, the method comprising:
a) receiving at least two scan models, the at least two scan models representing tooth placement;
b) aligning and merging the at least two scan models to generate a first model topology;
c) generating a second model topology;
d) separating each tooth in the generated second model topology;
e) manipulating teeth placement;
f) remerging the manipulated teeth placement into a revised second model topology; and
g) creating a dental prosthetic based on the revised second model topology.

6. The method of claim 5, wherein (c) further includes removing points on the at least two scan models which create holes.

7. The method of claim 5, wherein (c) further includes performing ortho-modifications using a three dimensional mesh incorporated on top of the first generated model topology.

8. The method of claim 5, wherein (c) further includes filtering of points from the at least two scan models, the filtering to remove noise.

9. The method of claim 5, wherein (d) further includes:
i. receiving a selection of one of the separated teeth in the generated second model topology;
ii. determining a rotational center for the selected tooth; and
iii. rotating the selected tooth into a desired position.
